(19) United States
(12) Patent Application Publication
(10) Pub. No.: US 2011/0032355 A1
(43) Pub. Date: Feb. 10, 2011

(54) MONITORING METHOD AND TERMINAL USING DIFFERENT MONITORING PRECISIONS

(75) Inventor: Qingyi Tong, Shenzhen (CN)

Correspondence Address: INTELLECTUAL PROPERTY / TECHNOLOGY LAW, PO BOX 14329, RESEARCH TRIANGLE PARK, NC, 27709, US

(73) Assignee: ZTE CORPORATION, Shenzhen, Guangdong Province (CN)

(21) Appl. No.: 12/937,559

(22) PCT Filed: Dec. 26, 2008
(86) PCT No.: PCT/CN08/73781

§ 371 Date: Oct. 13, 2010

(30) Foreign Application Priority Data
Apr. 14, 2008 (CN) 200810090183.5

(51) Int. Cl. H04N 7/18

(52) U.S. Cl. 348/143; 348/E07.085

(57) ABSTRACT

This invention discloses a monitoring method and terminal using different monitoring precisions. The method comprises: a user sends, to a monitoring terminal, monitoring precision setting information which includes one or more time periods and monitoring precisions corresponding to respective time periods; and according to the received monitoring precision setting information, the monitoring terminal applies, in each time period indicated in the received monitoring precision setting information, the corresponding monitoring precision to monitor a monitored place, and gives an alarm to the user when an alarming condition is met. Using the method of the present invention can enable the user to set the monitoring precision of the monitored place according to the user's practical requirement, make the monitoring precision automatically adapt to different monitoring situations, and not only decrease the false alarm, but also make the utilization of the monitoring terminal more convenient and meet the using requirement of the user.

### TECHNICAL FIELD

The present invention relates to the field of wireless communication technology, in particular to a monitoring method and terminal using different monitoring precisions.

### BACKGROUND OF THE INVENTION

Presently, traditional video monitoring systems including analogue monitoring and digital monitoring have been quite widely used, but the traditional video monitoring has some disadvantages by its nature, for instance, in the case when a monitored place is monitored, a specially assigned man should be on duty before the monitor. In some special situations, the monitoring cannot be implemented due to the limitation of the traditional video monitoring system, for example, in wild area where it is hard to build a network or a network has not been built yet, the traditional video monitoring system cannot be installed; in the situations such as a vehicle and a vessel during a long journey, a science investigation in wild area, a forest fire prevention and flood prevention, the objects to be monitored move at any time, thus the traditional video monitoring system cannot be used either; and in a company or at home, for the managers on a business trip or in the office, or for the employees having children or patients to be taken care of at home, they need to know what is going on in the company or at home at any time any place, which cannot be realized by the traditional monitoring system.

With the rapid development of the wireless network technology, in particular the application of the mobile network of the 3rd Generation (3G) Mobile Communication Technology, a kind of video monitoring system and terminal based on the mobile network emerges. One mobile terminal with a camera is placed at the monitored place. This mobile terminal, using an SIM (Subscriber Identity Model) card or a USIM (Universal Subscriber Identity Module) card as an identifier for identification, monitors the monitored place by the camera and gives an alarm to the manager (i.e. the user disposing this monitoring terminal) by a predetermined method (such as dialing video phone or sending MMS, etc.) when its warning condition is met by analyzing the image changes of the monitored place. The monitoring terminal judges whether the monitored placed is abnormal according to the changes (such as the changes between two adjacent frame images) of the video of the monitored place captured by the camera. To use such kind of terminal may raise different requirements at different time periods in some conditions, for example, when monitoring the domicile, if there is no body at home at daytime, high precision monitoring may be needed; but at night, since the family members have been back to home, if the monitor still make the monitoring with the same high sensitivity as at daytime, it may result in frequent alarms to the manager (family member). The unchangeable monitoring precision of the monitoring terminal will bring incontinence to the user.

### SUMMARY OF THE INVENTION

The technical problem to be solved by the present invention is to provide a monitoring method and terminal using different monitoring precision, to make the monitoring precision of the monitoring terminal automatically adapt to different monitoring situations to improve the user experience.

In order to solve the above problem, the present invention provides a monitoring method using different monitoring precisions, including: a user sends, to a monitoring terminal, monitoring precision setting information which includes one or more time periods and monitoring precisions corresponding to respective time periods; and according to the received monitoring precision setting information, the monitoring terminal applies, in each time period indicated in the received monitoring precision setting information, the corresponding monitoring precision to monitor a monitored place, and gives an alarm to the user when an alarming condition is met.

Also, the monitoring precision includes high precision, medium precision and low precision; the monitoring terminal using the high precision for monitoring refers to giving an alarm to the user when judging the difference between two frame images captured by a camera with a time interval M set by a system exceeds an alarming threshold set by the system, or when judging the difference between two frame images captured by the camera with an interval of P frames exceeds the alarming threshold set by the system; the monitoring terminal using the medium precision for monitoring refers to giving an alarm to the user when judging the difference between two frame images captured by the camera with a time interval N set by the system exceeds the alarming threshold set by the system, or when judging the difference between two frame images captured by the camera with an interval of Q frames exceeds the alarming threshold set by the system; the monitoring terminal using the low precision for monitoring refers to stopping the monitoring and giving no alarm to the user; wherein, the value of M is smaller than N, the value of P is smaller than Q, and the values of M, N, P and Q are determined by the monitoring terminal.

Also, the difference between the two frame images is one of the following differences: a sum of differences of the pixel values of pixel points at respective corresponding positions in the two frame images; a sum of differences of the pixel values of pixel points at respective corresponding positions in a monitored region set by the system in the two frame images; a difference of the average values of the pixel values of respective pixel points in the two frame images; and a difference of the average values of the pixel values of respective pixel points in the monitored region set by the system in the two frame images.

Also, the user using one of the following manners to send the monitoring precision setting information to the monitoring terminal: sending a short message service message including the monitoring precision setting information to the terminal, sending a multimedia information service message including the monitoring precision setting information to the terminal; and the terminal gives an alarm to the user through one of the following manners: sending a multimedia information service message including an alarming information to the user, sending a short message service message including an alarming information to the user.

In order to solve the above problem, the present invention provides a monitoring terminal using different monitoring precision, comprising the following modules: a camera, a network function module, and a master controlling module; the camera being configured to acquire video image data of a monitored place and to transmit the same to the master controlling module; the network function module is configured to receive monitoring precision setting information of a user which includes one or more time periods and monitoring precisions corresponding to respective time periods, and to transmit the same to the master controlling module; the network function module is also configured to give an alarm to the user after receiving an alarming instruction from the master controlling module; and the master controlling module is configured to, according to the received monitoring precision setting information sent from the network function module, apply, in each time period indicated in the received monitoring precision setting information, the corresponding monitoring precision to process the video image data acquired by the camera, and to send the alarming instruction to the network function module when judging it meets an alarming condition.

Also, the monitoring precision includes three level values, namely, high precision, medium precision and low precision; the master controlling module is configured to, when using the high precision for monitoring, give an alarm to the user when judging the difference between two frame images captured by the camera with a time interval M set by a system exceeds an alarming threshold set by the system, or when judging the difference between two frame images captured by the camera with an interval of P frames exceeds the alarming threshold set by the system; the master controlling module is also configured to, when using the medium precision for monitoring, give an alarm to the user when judging the difference between two frame images captured by the camera with a time interval N set by the system exceeds the alarming threshold set by the system, or when judging the difference between two frame images captured by the camera with an interval of Q frames exceeds the alarming threshold set by the system; and the master controlling module is also configured to, when using the low precision for monitoring, stop monitoring and give no alarm to the user; wherein the value of M is smaller than N, the value of P is smaller than Q, and the values of M, N, P and Q are determined by the monitoring terminal.

Also, the difference between the two frame images is one of the following differences: a sum of differences of the pixel values of pixel points at respective corresponding positions in the two frame images; a sum of differences of the pixel values of pixel points at respective corresponding positions in a monitored region set by the system in the two frame images; a difference of the average values of the pixel values of respective pixel points in the two frame images; and a difference of the average values of the pixel values of respective pixel points in the monitored region set by the system in the two frame images.

Also, the network function module is also configured to receive a short message service message including the monitoring precision setting information or a multimedia information service message including the monitoring precision setting information sent by the user, to obtain the monitoring precision setting information therefrom and to transmit the same to the master controlling module; and the network function module is also configured to give an alarm to the user by one of the following manners: sending the multimedia information service message including an alarming information to the user, sending the short message service message including the alarming information to the user.

Also, the master controlling module is also configured to send each time period and its corresponding monitoring precision in the monitoring precision setting information to a storing module; and the monitoring terminal also comprises a storing module configured to store each time period and its corresponding monitoring precision sent by the master controlling module.

Also, the monitoring terminal uses Subscriber Identity Module card or Universal Subscriber Identity Module card as an identifier for identification.

Using the method of the present invention can enable the user to set the monitoring precision of the monitored place according to the user's practical requirement, make the monitoring precision automatically adapt to different monitoring situations, and not only decrease the false alarm, but also make the utilization of the monitoring terminal more convenient and meet the using requirement of the user.

### DESCRIPTION OF THE DRAWINGS

FIG. 1 is a scheme of the composing of the modules in the monitoring terminal in an embodiment; and

FIG. 2 is a flow chart showing the monitoring method of a monitoring terminal using different monitoring precisions in an embodiment.

### PREFERRED EMBODIMENTS OF THE PRESENT INVENTION

In the present invention, the user sets the monitoring precision for the monitoring terminal to make it use different monitoring precisions to monitor a monitored place at different time periods, which not only decreases the false alarm, but also makes the utilization of the monitoring terminal more convenient and meet the using requirement of the user.

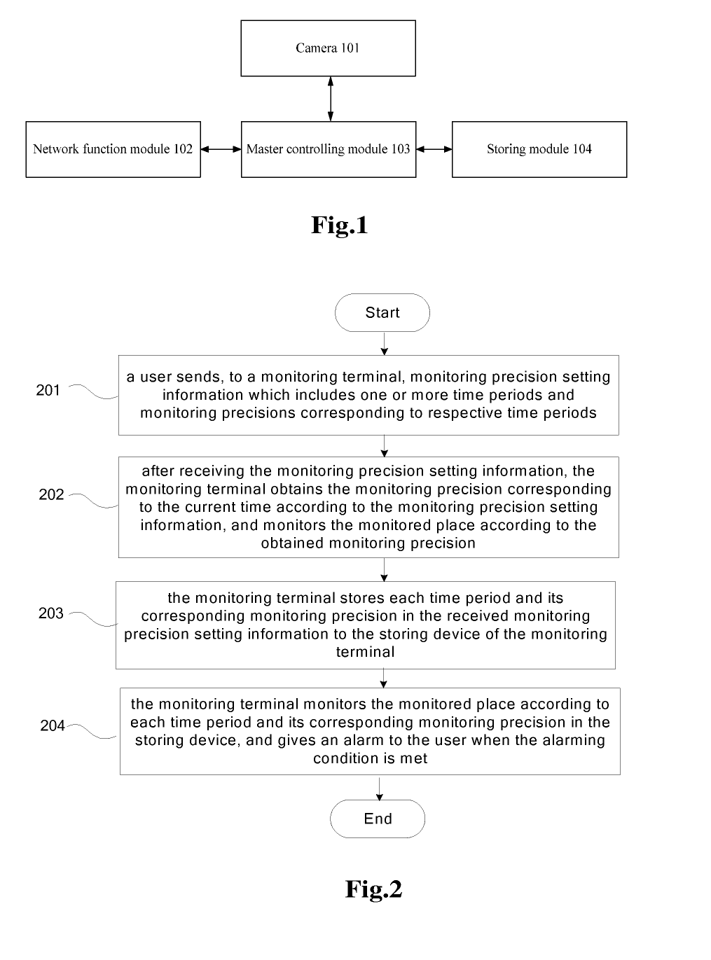

As shown in FIG. 1, the monitoring terminal being set with the monitoring precision comprises the following modules: a camera 101, a network function module 102, a master controlling module 103 and a storing module 104, wherein the master controlling module 103 is connected to the camera 101, the network function module 102 and the storing module 104, respectively;
the camera 101 is configured to acquire the video image data of the monitored place and to transmit the same to the master controlling module;
the network function module 102 is also configured to receive a short message including the monitoring precision setting information or a multimedia information service message including the monitoring precision setting information sent by the user, to obtain the monitoring precision setting information therefrom, and to transmit the same to the master controlling module 103, wherein the monitoring precision setting information includes one or more time periods and monitoring precisions corresponding to respective time periods; the network function module 102 is also configured to give an alarm to the user after receiving the alarming instruction from the master controlling module 103, wherein this module gives an alarm to the user by one of the following manners: sending the multimedia information service message including an alarming information to the user, sending the short message including the alarming information to the user;
the master controlling module 103 is configured to, according to the received monitoring precision setting information sent from the network function module 102, apply, in each time period indicated in the received monitoring precision setting information, the corresponding monitoring precision to process the video image data acquired by the camera 101, and to send the alarming instruction to the network function module 102 when judging it meets an alarming condition; and is also configured to send each time period and its corresponding monitoring precision in the monitoring precision setting information to the storing module 104.

The above monitoring precision includes three level values, namely, high precision, medium precision and low precision;
the master controlling module 103 is also configured to, when using the high precision for monitoring, give an alarm to the user when judging the difference between two frame images captured by the camera with a time interval M set by the system exceeds the alarming threshold set by the system, or when judging the difference between two frame images captured by the camera with the interval of P frames exceeds the alarming threshold set by the system; is also configured to, when using the medium precision for monitoring, give an alarm to the user when judging the difference between two frame images captured by the camera with the time interval N set by the system exceeds the alarming threshold set by the system, or when judging the difference between two frame images captured by the camera with the interval of Q frames exceeds the alarming threshold set by the system; and is also configured to, when using the low precision, stop monitoring and give no alarm to the user; wherein the value of M is smaller than N, the value of P is smaller than Q, and the values of M, N, P and Q are determined by the monitoring terminal.

The storing module 104 is configured to store each time period and its corresponding monitoring precision sent by the master controlling module 103.

The monitoring terminal uses Subscriber Identity Module card or Universal Subscriber Identity Module card as an identifier for identification.

As shown in FIG. 2, the method of setting the monitoring precision according to the time periods includes the following steps:
Step 201, a user sends, to a monitoring terminal, monitoring precision setting information which includes one or more time periods and monitoring precisions corresponding to respective time periods;
the user can send a short message or a multimedia information service message including the monitoring precision setting information to the terminal;
Step 202, after receiving the monitoring precision setting information, the monitoring terminal obtains the monitoring precision corresponding to the current time according to the monitoring precision setting information, and monitors the monitored place according to the obtained monitoring precision;
Step 203, the monitoring terminal stores each time period and its corresponding monitoring precision in the received monitoring precision setting information to the storing device of the monitoring terminal;
Step 204, the monitoring terminal monitors the monitored place according to each time period and its corresponding monitoring precision in the storing device, and gives an alarm to the user when the alarming condition is met.

The specific set parameters of the monitoring precision can be set by the manufacturer when releasing it. Next, it will be illustrated by citing examples. For instance, the monitoring precision is classified into three types:
1. when the monitoring precision is a high precision (for instance, its corresponding monitoring precision parameter value is set to be 0), the monitoring terminal judges whether the difference between two frame images captured by the camera with the time interval (such as 1 second) set by the system exceeds the alarming threshold set by the system, or judges whether the difference between two frame images captured by the camera with the interval of a plurality of frames (such as 25 frames) exceeds the alarming threshold set by the system; if the alarming threshold is exceeded, the monitoring terminal gives an alarm to the user via the manners such as video phone or MMS;
2. when the monitoring precision is the medium precision (its corresponding monitoring precision parameter value is set to be 1), the monitoring terminal compares whether the difference between the two frame images at the beginning and at the end of a period (such as 1 minute) set by the system exceeds the alarming threshold set by the system, or judges whether the difference between two frame images captured by the camera with the interval of a plurality of frames (such as 1500 frames) exceeds the alarming threshold set by the system; if the alarming threshold is exceeded, the monitoring terminal gives an alarm to the user via the manners such as video phone or MMS;
3. when the monitoring precision is low precision (its corresponding monitoring precision parameter value is set to be 2), the monitoring terminal stops the monitoring and gives no alarm to the user.

The above situation is merely an example, and the monitoring precision also can be classified into more than three levels.

The difference between the two frame images is one of the following differences: a sum of differences of the pixel values of pixel points at respective corresponding positions in the two frame images; a sum of differences of the pixel values of pixel points at respective corresponding positions in a monitored region set by the system in the two frame images; a difference of the average values of the pixel values of respective pixel points in the two frame images; and a difference of the average values of the pixel values of respective pixel points in the monitored region set by the system in the two frame images.

The terminal gives an alarm to the user by one of the following manners: sending a multimedia information service message including an alarming information to the user, sending a short message service message including an alarming information to the user.

It should be understood that those skilled in the art of the present invention are able to make corresponding equivalent changes or alterations according to the technical solution of the present invention and its concept, and all the changes or substitution should belong to the scope of protection of the appended claims of the present invention.

### INDUSTRY APPLICATION

Using the terminal of the present invention can enable the user to set the monitoring precision of the monitored place according to the user's practical requirement, make the monitoring precision automatically adapt to different monitoring situations, and not only decrease the false alarm, but also make the utilization of the monitoring terminal more convenient and meet the using requirement of the user.

1. A monitoring method using different monitoring precisions, wherein
a user sends, to a monitoring terminal, monitoring precision setting information which includes one or more time periods and monitoring precisions corresponding to respective time periods; and
according to the received monitoring precision setting information, the monitoring terminal applies, in each time period indicated in the received monitoring precision setting information, the corresponding monitoring precision to monitor a monitored place, and gives an alarm to the user when an alarming condition is met.

2. The method according to claim 1, wherein the monitoring precision includes high precision, medium precision and low precision;
the monitoring terminal using the high precision for monitoring refers to giving an alarm to the user when judging the difference between two frame images captured by a camera with a time interval M set by a system exceeds an alarming threshold set by the system, or when judging the difference between two frame images captured by the camera with an interval of P frames exceeds the alarming threshold set by the system;
the monitoring terminal using the medium precision for monitoring refers to giving an alarm to the user when judging the difference between two frame images captured by the camera with a time interval N set by the system exceeds the alarming threshold set by the system, or when judging the difference between two frame images captured by the camera with an interval of Q frames exceeds the alarming threshold set by the system;
the monitoring terminal using the low precision for monitoring refers to stopping the monitoring and giving no alarm to the user;
wherein, the value of M is smaller than N, the value of P is smaller than Q, and the values of M, N, P and Q are determined by the monitoring terminal.

3. The method according to claim 2, wherein
the difference between the two frame images is one of the following differences: a sum of differences of the pixel values of pixel points at respective corresponding positions in the two frame images; a sum of differences of the pixel values of pixel points at respective corresponding positions in a monitored region set by the system in the two frame images; a difference of the average values of the pixel values of respective pixel points in the two frame images; and a difference of the average values of the pixel values of respective pixel points in the monitored region set by the system in the two frame images.

4. The method according to claim 1, wherein
the user using one of the following manners to send the monitoring precision setting information to the monitoring terminal: sending a short message service message including the monitoring precision setting information to the terminal, sending a multimedia information service message including the monitoring precision setting information to the terminal; and
the terminal gives an alarm to the user through one of the following manners: sending a multimedia information service message including an alarming information to the user, sending a short message service message including an alarming information to the user.

5. A monitoring terminal using different monitoring precision, comprising the following modules: a camera, a network function module, and a master controlling module; the camera being configured to acquire video image data of a monitored place and to transmit the same to the master controlling module; wherein
the network function module is configured to receive monitoring precision setting information of a user which includes one or more time periods and monitoring precisions corresponding to respective time periods, and to transmit the same to the master controlling module; the network function module is also configured to give an alarm to the user after receiving an alarming instruction from the master controlling module; and
the master controlling module is configured to, according to the received monitoring precision setting information sent from the network function module, apply, in each time period indicated in the received monitoring precision setting information, the corresponding monitoring precision to process the video image data acquired by the camera, and to send the alarming instruction to the network function module when judging it meets an alarming condition.

6. The terminal according to claim 5, wherein
the monitoring precision includes three level values, namely, high precision, medium precision and low precision;
the master controlling module is configured to, when using the high precision for monitoring, give an alarm to the user when judging the difference between two frame images captured by the camera with a time interval M set by a system exceeds an alarming threshold set by the system, or when judging the difference between two frame images captured by the camera with an interval of P frames exceeds the alarming threshold set by the system;
the master controlling module is also configured to, when using the medium precision for monitoring, give an alarm to the user when judging the difference between two frame images captured by the camera with a time interval N set by the system exceeds the alarming threshold set by the system, or when judging the difference between two frame images captured by the camera with an interval of Q frames exceeds the alarming threshold set by the system; and
the master controlling module is also configured to, when using the low precision for monitoring, stop monitoring and give no alarm to the user;
wherein the value of M is smaller than N, the value of P is smaller than Q, and the values of M, N, P and Q are determined by the monitoring terminal.

7. The terminal according to claim 6, wherein the difference between the two frame images is one of the following differences: a sum of differences of the pixel values of pixel points at respective corresponding positions in the two frame images; a sum of differences of the pixel values of pixel points at respective corresponding positions in a monitored region set by the system in the two frame images; a difference of the average values of the pixel values of respective pixel points in the two frame images; and a difference of the average values of the pixel values of respective pixel points in the monitored region set by the system in the two frame images.

8. The terminal according to claim 5, wherein
the network function module is also configured to receive a short message service message including the monitoring precision setting information or a multimedia information service message including the monitoring precision setting information sent by the user, to obtain the monitoring precision setting information therefrom and to transmit the same to the master controlling module; and the network function module is also configured to give an alarm to the user by one of the following manners: sending the multimedia information service message including an alarming information to the user, sending the short message service message including the alarming information to the user.

9. The terminal according to claim 5, wherein
the master controlling module is also configured to send each time period and its corresponding monitoring precision in the monitoring precision setting information to a storing module; and
the monitoring terminal also comprises a storing module configured to store each time period and its corresponding monitoring precision sent by the master controlling module.

10. The terminal according to claim 5, wherein
the monitoring terminal uses Subscriber Identity Module card or Universal Subscriber Identity Module card as an identifier for identification.
